(19) United States
(12) Patent Application Publication
(10) Pub. No.: US 2009/0221277 A1
(43) Pub. Date: Sep. 3, 2009

(54) DISCONNECTION TECHNIQUES IN WIRELESS COMMUNICATIONS NETWORKS

(75) Inventors: Yury Fomin, Pleasanton, CA (US); Pradeep Kumar, Sunnyvale, CA (US)

Correspondence Address: KACVINSKY LLC;4500 BROOKTREE ROAD, SUITE 102, WEXFORD, PA, 15090, US

(73) Assignee: PALM, INC., SUNNYVALE, CA (US)

(21) Appl. No.: 12/040,131

(22) Filed: Feb. 29, 2008

(51) Int. Cl. H04M 3/00

(52) U.S. Cl. 455/418

(57) ABSTRACT

An apparatus includes a host, and a communications control module. The communications control module exchanges information with a communications network, such as a Universal Mobile Telecommunications System (UMTS) network. The host determines whether a termination condition exists. Based on this determination, the communications control module performs a signaling connection release indication procedure when a termination condition exists.

### BACKGROUND

Mobile computing devices, such as smart phones, may have wireless communications capabilities to provide features, such as mobile telephony, mobile e-mail access, web browsing, reception of content (e.g., video and audio), and so forth. Also, such devices may provide various processing capabilities. For example, mobile devices may provide personal digital assistant (PDA) features, including word processing, spreadsheets, and synchronization of information with a desktop computer.

Universal Mobile Telecommunications System (UMTS) is a wireless communications technology that has been established by the Third Generation Partnership Project (3GPP). UMTS networks typically employ wideband code division multiple access (WCDMA) techniques for the exchange of wireless signals among devices. UMTS networks provide for the exchange of information at high data rates. Thus, UMTS networks support telephony, as well as the transfer of data and content (e.g., video and audio).

Typically, batteries provide operational power for mobile devices. Therefore, it is desirable to prolong battery life by reducing a mobile device's power demand. This may involve making one or more of its operations more power efficient.

To conserve mobile device power, communications systems provide certain low power operational states that a mobile device may enter under certain conditions. For example, UMTS provides an idle mode for user devices. Unfortunately, an unduly long amount of time may be required to enter such low power states. As a result, excessive battery power may be consumed.

### BRIEF DESCRIPTION OF THE DRAWINGS

FIG. 1 is a diagram of an exemplary operational environment.

FIG. 2 is a diagram showing operational features of a user device.

FIG. 3 is a flow diagram.

FIG. 4 is a diagram of an exemplary device architecture.

FIG. 5 is a diagram of an exemplary device implementation.

FIG. 6 is a flow diagram.

FIG. 7 is a graph showing performance characteristics.

### DETAILED DESCRIPTION

Various embodiments may be generally directed to techniques for managing power consumption. For instance, an apparatus includes a host, and a communications control module. The communications control module exchanges information with a communications network. The host determines whether a termination condition exists. Based on this determination, the communications control module performs a signaling connection release indication procedure when a termination condition exists.

Various advantages may be obtained through such techniques. For instance, power consumption may be reduced in mobile devices. Such reductions may extend battery life and increase user convenience.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include other combinations of elements in alternate arrangements as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment” or “in an embodiment” in various places in the specification are not necessarily all referring to the same embodiment.

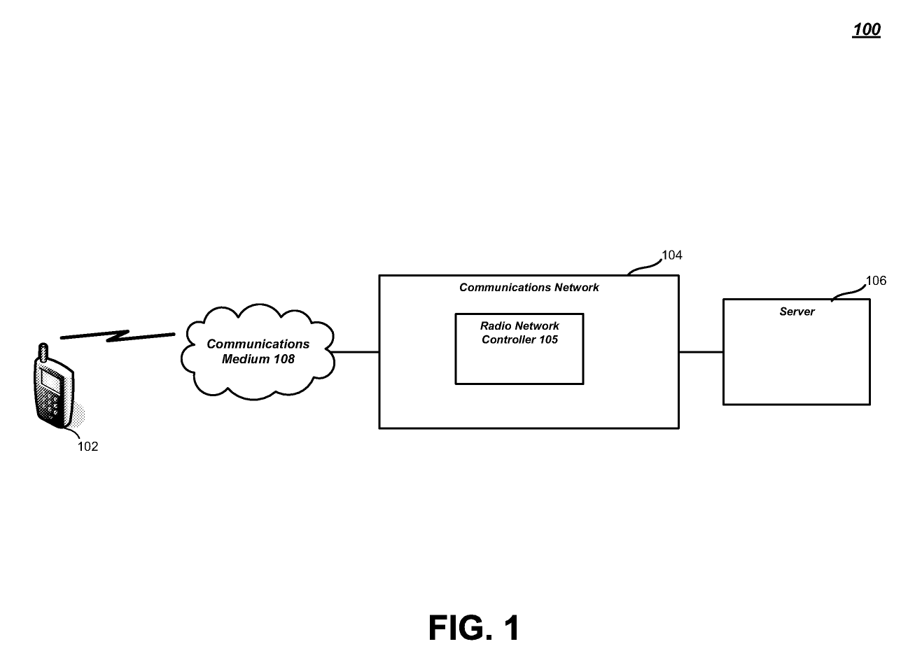

FIG. 1 is a diagram of an operational environment 100. This environment includes a user device 102, a communications network 104, a server 106, and a communications medium 108.

User device 102 is capable of engaging in communications with remote devices through communications network 104. Such communications may be wireless. Accordingly, device 102 may be a mobile phone, a smartphone, a PDA, a computing device (e.g., a laptop computer, a desktop computer, etc.), and/or other types of devices. Embodiments are not limited to these examples.

Communications network 104 may provide wireless access for user device 102 through one or more cells. Thus, communications network 104 may be a UMTS network. However, other types of networks may be employed. Communications network 104 includes entities (e.g., device(s)) that exchange information with other devices, such as user device 102 and server 106. In addition, such entities may perform operations associated with one or more protocols. For example, FIG. 1 shows communications network 104 including a radio network controller (RNC) 105.

RNC 105 may be implemented in hardware, software, firmware, or any combination thereof. In the context of UMTS, RNC 105 may interact with user device 102 in accordance with the UMTS radio resource control protocol (RRC). RRC handles control plane signalling between user device 102 and radio access portions of communications network 104.

Through communications network 104, user device 102 may exchange information with other devices. For instance, user device 102 may exchange information with server 106.

FIG. 1 shows that communications network 104 provides communications medium 108. Communications medium 108 may be wireless. Accordingly, this medium may comprise one or more portions of the radio frequency (RF) spectrum. Various channels may be allocated through communications medium 108. For example, in embodiments employing UMTS, such channels may include dedicated uplink and downlink channels, as well as shared or common uplink and downlink channels.

As described above, server 106 may provide user device 102 with information via communications network 104. For example, server 106 may be a mail server that provides user device 102 with e-mails according to various techniques and/or protocols.

For instance, server 106 may employ push e-mail techniques and/or protocols to deliver e-mail. Push e-mail (or push mail) involves the active transfer of e-mails from a server (e.g., server 106) to a client device (e.g., user device 102).

For instance, server 106 may employ push e-mail techniques and/or protocols to deliver e-mail. Push e-mail (or push mail) involves the active transfer of e-mails from a server (e.g., server 106) to a client device (e.g., user device 102). More particularly, when push mail is employed, the client device and the server may operate according to a heartbeat procedure (or ping).

A heartbeat procedure (or ping) involves the client device establishing a session with the server that enables data to be transferred from the server to the client device. Such a session may be a hypertext transfer protocol (HTTP), session or an HTTP over secure socket layer (HTTPS) session. Embodiments, however, are not limited to these types of sessions for push mail. The session may have a maximum inactivity time or timeout duration. Once this time or duration expires, the session may end or “timeout”.

Through the session, the client device may “ping” the server with a message (e.g., a request message). Upon receipt of the ping, the server may respond with new mail synchronization information, respond with a messaging indicating no new information updates, or not respond at all. Following these outcomes, the session may timeout according to various procedures. When the timeout occurs, the heartbeat or ping is complete. Client devices may initiate heartbeats or pings repeatedly.

In contrast, “pull e-mail” involves the client device polling the server to see if it has any new e-mail. These techniques and protocols are provided as examples and not as limitations. Accordingly, techniques other than push mail and/or pull mail may be employed.

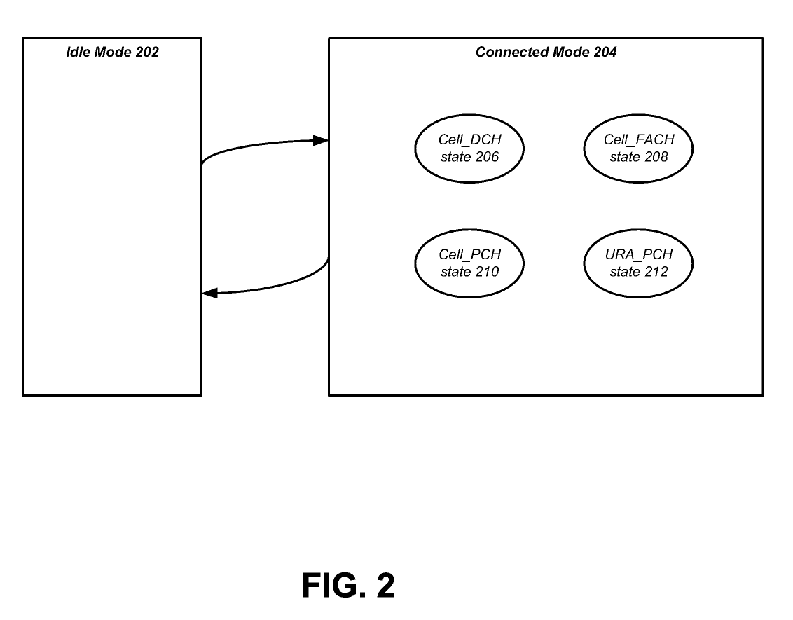

When performing communications operations associated with applications (such as push mail), situations involving excessive power consumption may arise. For instance, upon the conclusion of e-mail communications (such as the completion of a heartbeat procedure (or ping), or when a mail application is closed), a prolonged transition into a power saving mode (such as into a UMTS idle mode) may occur. Such operational characteristics are described below with reference to FIG. 2.

UMTS provides various operational modes and states. Examples of these modes and states are provided in FIG. 2. In particular, FIG. 2 is a diagram showing operational features of a user device, such as user device 102. The user device may operate according to various modes. For example, FIG. 2 shows an idle mode 202 and a connected mode 204. These modes are described in the context of FIG. 1.

User device 102 may enter idle mode 202 upon application of operational power. At this point, user device 102 may choose a network and search for a suitable cell to select. Once selected, user device 102 tunes to the cell's control channel. At this point, user device 102 may register with the selected cell. Thus, when in idle mode 202, user device 102 may receive system information from the selected cell.

Additionally, user device 102 may perform cell reselection in idle mode 202. Thus, if user device 102 finds a further cell that is more suitable, it may tune to the control channel of this further cell. Also, user device 102 may register with this further cell.

User device 102 may transition from idle mode 202 to connected mode 204. In particular, this transition may occur when user device 102 establishes a radio resource control (RRC) connection with communications network 104. User device 102 may initiate this connection by transmitting a request to communications network 104.

An RRC connection provides for control plane signaling between user device 102 and radio access portions of communications network 104. This signaling allows for various operations to be performed. Such operations include (but are not limited to) connection establishment and release, system information broadcasting, paging, and power control.

Conversely, user device 102 may transition from connected mode 204 to idle mode 202 when the RRC connection is released or when the RRC connection fails. In the context of UMTS, a user device does not conventionally initiate a transition from connected mode 204 into idle mode 202. More particularly, such transitions must be initiated by communications network 104.

FIG. 2 shows that user device 102 may operate in various states while it is in connected mode 204. For example, FIG. 2, shows a Cell_DCH state 206, a Cell_FACH state 208, a Cell_PCH state 210, and a URA_PCH state 212.

In CELL_DCH state 206, user device 102 is allocated a dedicated physical uplink channel and a dedicated physical downlink channel. User device 102 may employ these dedicated channels, as well as shared transport channels for communications.

In CELL_FACH state 208, user device 102 is not allocated any dedicated physical channels. In the downlink, user device 102 monitors a forward access channel (FACH). In the uplink, user device 102 may be assigned a shared transport channel (e.g. a random access channel (RACH)).

In CELL_PCH state 210, user device 102 is not allocated any dedicated physical channels. Moreover, in this state, user device 102 is not able to engage in uplink communications. User device 102 selects a paging channel (PCH) with the algorithm, and uses discontinuous reception (DRX) for monitoring the selected PCH via an associated paging indication channel (PICH).

In URA_PCH state 212, user device 102 is not allocated any dedicated channels. Moreover, in this state, user device 102 is not able to engage in uplink communications. User device 102 selects a PCH with the algorithm, and uses DRX for monitoring the selected PCH via an associated PICH. No uplink activity is possible.

As described above, user devices may consume excessive power due to a prolonged transition into an idle mode (e.g., a prolonged transition from connected mode 204 to idle mode 202).

An example of such a prolonged transition is described with reference to a push mail application employed across a UMTS network. However, such transitions may occur with other applications and other communications networks. For purposes of convenience, this example is described in the arrangement of FIG. 1 and the features of FIG. 2. However, embodiments are not limited to this context.

Communications applications (such as push mail, various data applications, and so forth) involve the establishment of a connection between a user device (e.g., user device 102) and a communications network (e.g., communications network 104). When a connection is initiated by an e-mail server (e.g., an exchange server), the device and the network establish dedicated channels to support that procedure. Thus, user device 102 may be in (or placed in) Cell_DCH state 206 for this procedure.

During push mail operations, user device 102 receives one or more pings from server 106. For UMTS networks, a typical time for user device 102 to receive the ping is approximately 4 seconds.

After user device 102 has completed the heartbeat procedure, it will move to URA_PCH state 212. Typical time durations for this state are between approximately 5-15 seconds. However, in some networks, user device 102 may be in URA_PCH state 212 for an extended time interval, such as 30 seconds.

Next, user device 102 may transition from URA_PCH state 212 to Cell_FACH state 208 and stay for another 40-160 seconds, depending on the implementation of communications network 104 (which may be determined by the network vendor's implementation). Such a time interval in Cell_FACH state 208 is referred to herein as a “Cell_FACH tail”, as it precedes a transition into idle mode 202.

Keeping user device 102 in Cell_FACH state 208 may be expensive from a power consumption perspective. For instance, typical current demand in this state is between approximately 150 and 200 milliamps (mA). Moreover, the Cell_FACH tail may reduce a device's battery life for an estimated 12%-18%.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented, unless otherwise indicated. In addition, the given logic flow may be implemented by a hardware element, a software element executed by a processor, or any combination thereof. The embodiments are not limited in this context.

As described above, 3GPP Standards specify that a user device is a slave to the network in terms of its configuration and its connectivity to the network. Thus, when a user device concludes any communications (e.g., voice, data, etc.), it has no direct way to disconnect from the network (e.g., release its RRC connection). Instead, the user device can merely initiate a disconnection procedure and wait to be disconnected by the network. In the context of UMTS, a disconnected user device may then enter idle mode 202, where its power consumption is decreased. Unfortunately, this waiting may cause the user device to consume substantial energy, which leads to shortened battery times.

Currently, the UMTS RRC provides a procedure called ‘Signaling Connection Release Indication’, which may allow for user devices to disconnect from networks more quickly. Conventionally, this procedure is used by a user device to indicate to the communications network that one of its signaling connections has been released. In turn, this procedure may prompt the communications network to release an RRC connection.

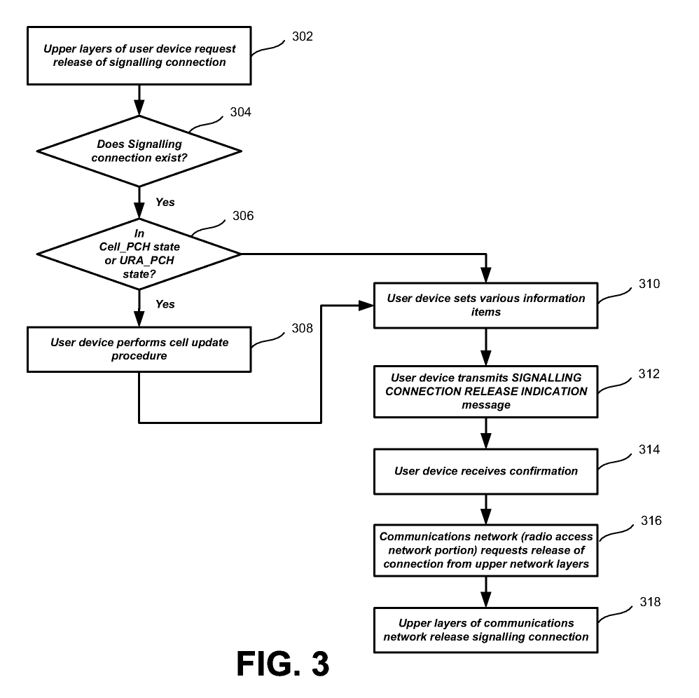

FIG. 3 is a logic flow diagram showing an exemplary sequence involving this procedure. This sequence includes a block 302. At this block, upper layers within a user device generate a request that the signaling connection for a specific core network (CN) domain be released (aborted).

Based on this request, the user device determines at a block 304 whether a signaling connection for the specified CN connection exists. This determination may involve checking the variable ESTABLISHED_SIGNALLING_CONNECTIONS. In particular, it is determined whether, in this variable, a signaling connection for the specific CN domain identified with the IE “CN domain identity” exists.

If such a signaling connection is identified, then the user device initiates connection release indication procedure, which is described below with reference to blocks 306 through 314.

As indicated by block 306, if the user device is in the CELL_PCH state or the URA_PCH state, then a cell update procedure may be performed at a block 308.

At a block 310, the user device may set various information items. In particular, the information element (IE) “CN Domain Identity” may be set to the value specified at block 302. The value of this IE indicates the CN domain whose associated signalling connection the user device's upper layers are indicating to be released.

Also at block 310, the signalling connection identified at block 302 may be removed from the variable ESTABLISHED_SIGNALLING_CONNECTIONS.

FIG. 3 further shows that, at a block 312, the user device transmits a SIGNALLING CONNECTION RELEASE INDICATION message to the communications network. This may be transmitted on a dedicated control channel (DCCH) using acknowledged mode radio link control (AM RLC).

At a block 314, the user device receives a confirmation that the message sent at block 312 was successfully received.

Upon reception of a SIGNALLING CONNECTION RELEASE INDICATION message, the communications network (i.e., its radio access network) requests the release of the signalling connection from upper layers at a block 316. Accordingly, at a block 318, upper layers of the communications network may then initiate the release of the signalling connection.

Embodiments may utilize this procedure to shorten transitions into idle modes. Accordingly embodiments may advantageously reduce power consumption of user devices.

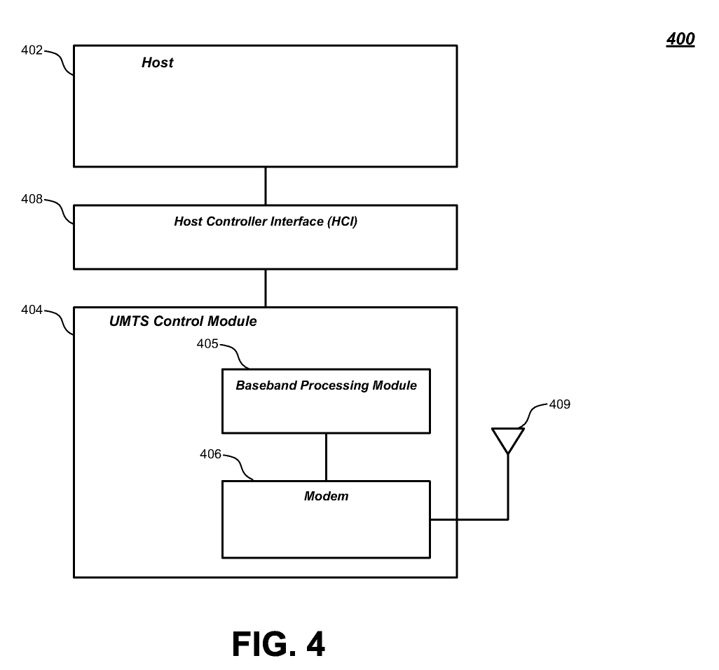

FIG. 4 is a block diagram showing a device architecture 400, which may be used for user devices, such as user device 102. Although this architecture is described in the context of UMTS communications, it may be employed with other wireless communications technologies.

The device architecture of FIG. 4 includes a host 402, a UMTS control module 404, and a host controller interface (HCI) 408. These elements may be implemented in hardware, software, firmware, or any combination thereof. Host 402 is responsible for functions involving user applications and higher protocol layers (e.g., e-mail, telephony, web browsing, and so forth), while UMTS control module 404 is responsible for lower layer protocols. More particularly, UMTS control module 404 is responsible for UMTS-specific communications and protocols with other devices. In addition, UMTS control module 404 exchanges wireless signals with remote devices.

FIG. 4 shows that UMTS control module 404 includes a baseband processing module 405 and a modem 406. These elements may be implemented in hardware, software, firmware, or any combination thereof. Baseband processing module 405 may perform operations involving various protocols. For example, baseband processing module 405 may perform RRC protocol operations.

Modem 406 may perform modulation and demodulation operations to prepare baseband signals for wireless transmission, and to generate information from received wireless signals. As shown in FIG. 4, modem 405 is coupled to an antenna 409, which exchanges wireless signals with other devices. Accordingly, modem 406 may include components, such as electronics that, allow it to exchange wireless signals via antenna 409. Examples of such components include (but are not limited to) upconverters, downconverters, amplifiers, and filters.

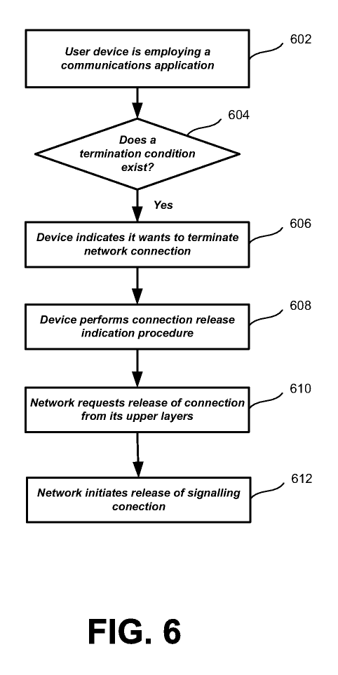

As shown in FIG. 4, host 402 and UMTS control module 404 exchange information across HCI 408. HCI 408 may be implemented in hardware, software, firmware, or any combination thereof. Information exchanged across HCI 408 may include commands received from host 402, and information transmitted to host 402. HCI 408 defines a set of messages, which provide for this exchange of information. For example, in embodiments, HCI 408 may provide a message called “CM_CALL_CMD_BATTERY SAVE”, as described below with reference to FIG. 6.

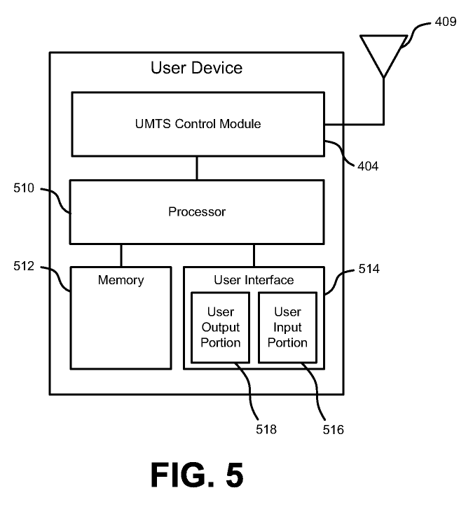

As described above, the architecture of FIG. 4 may be implemented in hardware, software, firmware, or any combination thereof. One such implementation is shown in FIG. 5. This implementation includes a processor 510, a memory 512, and a user interface 514. In addition, the implementation of FIG. 5 includes UMTS control module 404, and antenna 409. These elements may be implemented as described above with reference to FIG. 4.

As shown in FIG. 5, processor 510 is coupled to UMTS control module 404, memory 512, and user interface 514. Processor 510 controls device operation. Processor 510 may be implemented with one or more microprocessors that are each capable of executing software instructions stored in memory 512.

Memory 512 may include various types of memory. Exemplary memory types include (but are not limited to) random access memory (RAM), read only memory (ROM), flash memory, and so forth. Memory 512 stores information in the form of data and software components (also referred to herein as modules). These software components include instructions that can be executed by processor 510. Various types of software components may be stored in memory 512. For instance, memory 512 may store software components that control the operations of UMTS control module 404. Also, memory 512 may store software components that provide for the functionality of host 402 and HCI interface 408.

In addition, memory 512 may store software components that control one or more operations of user interface 514. As shown in FIG. 5, user interface 514 is also coupled to processor 510. User interface 514 facilitates the exchange of information with a user. FIG. 5 shows that user interface 514 includes a user input portion 516 and a user output portion 518. User input portion 516 may include one or more devices that allow a user to input information. Examples of such devices include keypads, touch screens, and microphones. User output portion 518 allows a user to receive information from the user device. Thus, user output portion 518 may include various devices, such as a display, and one or more audio speakers. Exemplary displays include liquid crystal displays (LCDs), and video displays.

The elements shown in FIG. 5 may be coupled according to various techniques. One such technique involves coupling UMTS control module 404, processor 510, memory 512, and user interface 514 through one or more bus interfaces. However, other techniques may be employed. In addition, each of these components is coupled to a power source, such as a removable and/or rechargeable battery pack (not shown).

As described above, the current UMTS procedure involving the SIGNALING CONNECTION RELEASE INDICATION message may be employed to shorten transitions into idle modes.

FIG. 6 is a diagram of a logic flow in which a user device (e.g., user device 102) initiates a connection release. This flow includes a block 602 in which the user device is employing a communications application. Examples of such communications applications include telephony, messaging (e.g., SMS and/or MMS), web browsing, and/or e-mail. In the context of FIGS. 4 and 5, such applications may be performed by host 402.

At a block 604, the user device (e.g., host 402 within device architecture 400) determines whether a termination condition exist. This may comprise determining whether there are any pending calls with the communications network. Also, this may comprise determining which applications are currently running. Based on such determinations, the user device may conclude that a terminating condition exists when there is an absence of pending calls with the communications network and there are no communications applications (other than e-mail application(s)) running.

For example, a termination condition may exist when there are no voice or data calls, no mail application running, and no browser operating. More particularly, a termination condition may exist when: 1) there is no circuit-switched service (CS) call (e.g. voice, tty) active, and 2) there is packet data service (PS) call active, and 3) no communications applications (e.g., web browsers, etc.) other than an e-mail application is running.

Additionally or alternatively, a termination condition may exist when: 1) a push mail ping has been concluded (and another ping has not commenced), and 2) the device is in CELL_FACH state 208, and 3) there is no circuit-switched service (CS) call (e.g. voice, tty) active, and 4) there is packet data service (PS) call active, and 5) no communications applications (e.g., web browsers, etc.) other than an e-mail application is running.

The embodiments, however, are not limited to these examples. Thus, a termination condition may exist when other situations occur.

If a termination condition exists, then operation proceeds to a block 606. At this block, the user device indicates that it wants to terminate its connection with the network. For example, in the context of FIG. 4, this may involve host 402 sending a message to UMTS control module 404 to initiate a Signaling Connection Release Indication procedure. In embodiments, this message is called a CM_CALL_CMD_BATTERY_SAVE message. This message may be sent across HCI 408.

At a block 608, a connection release indication procedure is performed. For example, this may involve performing blocks 306-314 of FIG. 3. As described above, this involve the transmission of a SIGNALLING CONNECTION RELEASE INDICATION message to the communications network.

Upon reception of this message, the communications network (i.e., its radio access network) requests the release of the signalling connection from upper layers at a block 610. Accordingly, at a block 612, upper layers of the communications network may then initiate the release of the signalling connection. Thus, the user device may enter an idle mode (e.g., idle mode 202).

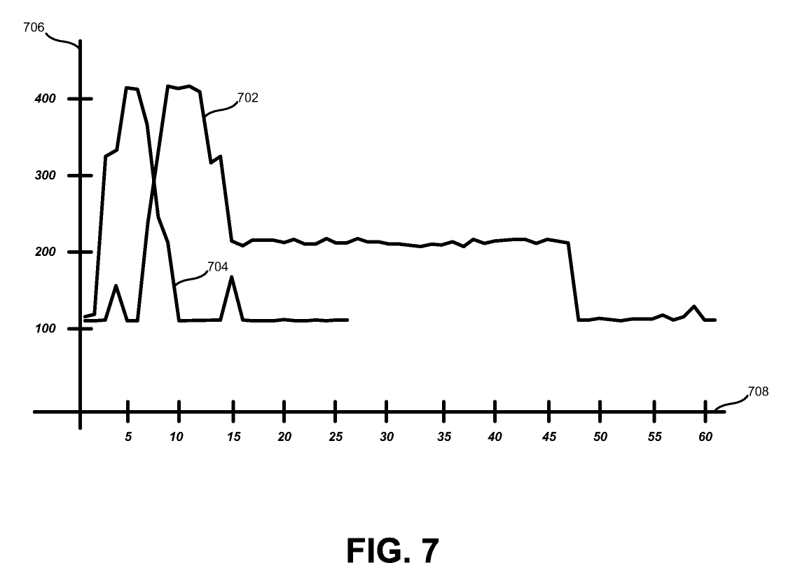

FIG. 7 is a graph showing performance changes in power consumption when techniques described herein are employed. In particular, FIG. 7 includes curves 702 and 704. These curves each show device power consumption (indicated by an axis 706) as a function of time (indicated by an axis 708).

Curve 702 shows power consumption according to conventional UMTS techniques. In contrast, curve 704 shows power consumption when a user device triggers the SIGNALING CONNECTION RELEASE INDICATION message as soon as the user device moved to Cell_FACH state 208 after inactivity time at Cell_DCH state 206.

More particularly, this triggering of the SIGNALING CONNECTION RELEASE INDICATION message was done for every packet data service (PS) connection, including browsing, downloading etc. However, in embodiments, such triggering may be performed only for e-mail applications.

As shown in FIG. 7, curve 704 exhibits a substantial reduction in power consumption from the power consumption of curve 702. Moreover, after the communications network received the RRC “SIGNALING CONNECTION RELEASE INDICATION message, the communications network sent an RRC Connection Release message, and it took less than two seconds to disconnect from network. During these two seconds, the user device performed some basic procedures like Cell Update, and BCH listening.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Although the above description was made in the context of UMTS systems, the techniques described herein may be employed with other wireless telecommunications systems, such cellular radiotelephone systems compliant with the Third-Generation Partnership Project (3GPP), 3GPP2, and so forth. However, the embodiments are not limited to these examples. For example, various 4G systems may be employed. Moreover, embodiments are not limited to particular versions or releases of UMTS.

Further, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
operating in a connection mode with a communications network
determining whether a termination condition exists;
based on the determination, performing a signaling connection release indication procedure when a termination condition exists;
operating in an idle mode with the communications network after completion of the Signaling Connection Release Indication procedure.

2. The method of claim 1, wherein said determining comprises determining whether any pending calls with the communications network exist.

3. The method of claim 1, wherein said determining comprises determining whether any communications applications are running.

4. The method of claim 1, wherein said determining comprises concluding that a terminating condition exists when there is an absence of pending calls with the communications network and there are no communications applications running.

5. The method of claim 1, wherein said determining comprises concluding that a termination condition exists when there is an absence of pending calls with the communications network and an e-mail application is the only running communications application.

6. The method of claim 1, wherein said operating in the connection mode comprises having a radio resource control (RRC) protocol with the communications network.

7. The method of claim 1, wherein performing the signaling connection release indication procedure comprises sending the communications network a SIGNALLING CONNECTION RELEASE INDICATION message.

8. The method of claim 1, further comprising sending a message to a control module across a host controller interface (HCI) to initiate the signaling connection release indication procedure.

9. The method of claim 1, wherein the communications network is a Universal Mobile Telecommunications System (UMTS) network.

10. An apparatus, comprising:
a host, and a communications control module;
wherein the communications control module is to exchange information with a communications network; and
wherein the host is to determine that a termination condition exists, and based on the determination, the communications control module is to perform a signaling connection release indication procedure.

11. The apparatus of claim 10, wherein said host is to determine that a terminating condition exists when there is an absence of pending calls with the communications network and there are no communications applications running.

12. The apparatus of claim 10, wherein said host is to determine that a termination condition exists when there is an absence of pending calls with the communications network and an e-mail application is the only running communications application.

13. The apparatus of claim 10, wherein the communications network is a Universal Mobile Telecommunications System (UMTS) network.

14. The apparatus of claim 10, further comprising a host controller interface (HCI) to provide for the exchange of information between the host and the communications control module.

15. The apparatus of claim 10, wherein the host is to send a message to the communications control module across the HCI, the message to initiate the signaling connection release indication procedure.

16. The apparatus of claim 10, wherein the communications control module is to send the communications network a SIGNALLING CONNECTION RELEASE INDICATION message when performing the signaling connection release indication procedure.

17. The apparatus of claim 10, wherein the host is to perform one or more user applications.

18. An article, comprising a machine-readable storage medium containing instructions that if executed enable a system to:
operate in a connection mode with a communications network
determine whether a termination condition exists;
based on the determination, perform a signaling connection release indication procedure when a termination condition exists; and
operate in an idle mode with the communications network after completion of the Signaling Connection Release Indication procedure.

19. The article of claim 18, wherein the machine-readable storage medium contains instructions that if executed enable a system to conclude that a terminating condition exists when there is an absence of pending calls with the communications network and there are no communications applications running.

20. The article of claim 18, wherein the machine-readable storage medium contains instructions that if executed enable a system to conclude that a termination condition exists when there is an absence of pending calls with the communications network and an e-mail application is the only running communications application.
